(19) United States
(12) Patent Application Publication
(10) Pub. No.: US 2023/0245470 A1
(43) Pub. Date: Aug. 3, 2023

(54) DRIVING ASSISTANCE APPARATUS, VEHICLE, DRIVING ASSISTANCE METHOD, AND STORAGE MEDIUM

(71) Applicants: HONDA MOTOR CO., LTD., Tokyo (JP); HITACHI ASTEMO, LTD., Hitachinaka-shi (JP)

(72) Inventors: Masayuki NAKATSUKA, Wako-shi (JP); Takeshi KIBAYASHI, Wako-shi (JP); Keiichiro NAGATSUKA, Hitachinaka-shi (JP); Hirofumi IKOMA, Hitachinaka-shi (JP)

(21) Appl. No.: 18/100,753

(22) Filed: Jan. 24, 2023

(30) Foreign Application Priority Data
Feb. 1, 2022 (JP) 2022-014404

(51) Int. Cl. G06V 20/58; G06V 20/56; G06T 7/60; B60W 50/16; B60W 40/04; B60W 40/105

(52) U.S. Cl. CPC G06V 20/584; G06V 20/588; G06T 7/60; B60W 50/16; B60W 40/04; B60W 40/105; G06T 2207/30256; B60W 2050/143

(57) ABSTRACT

The present invention provides a driving assistance apparatus that assists driving of a vehicle, comprising: an image capturing unit configured to capture an image of the front of the vehicle; an identification unit configured to identify a traffic light in the image obtained by the image capturing unit; a detection unit configured to detect, from the image, an installation height of the traffic light identified by the identification unit; and a determination unit configured to determine whether or not the traffic light identified by the identification unit is a target traffic light indicating whether or not the vehicle travels, based on the installation height detected by the detection unit.

### CROSS-REFERENCE TO RELATED APPLICATION(S)

This application claims priority to and the benefit of Japanese Patent Application No. 2022-014404 filed on Feb. 1, 2022, the entire disclosure of which is incorporated herein by reference.

### BACKGROUND OF THE INVENTION

### Field of the Invention

The present invention relates to a driving assistance apparatus, a vehicle, a driving assistance method, and a storage medium.

### Description of the Related Art

Japanese Patent No. 5883833 describes technology for, when one or a plurality of traffic lights are identified in an image obtained by an image capturing device, estimating a traveling locus of a self-vehicle and identifying a traffic light as a control input from among the one or plurality of traffic lights, based on a lateral position (traveling lateral position) of each traffic light with respect to the traveling locus and a lateral position (front lateral position) of each traffic light with respect to a straight line ahead of the self-vehicle.

As described in Japanese Patent No. 5883833, merely identifying the traffic light as the control input based on the lateral position of each traffic light may erroneously identify a traffic light that satisfies the condition of the lateral position of the traffic light but has little relation with the self-vehicle, such as a pedestrian traffic light or a blinker light, as the traffic light (that is, a traffic light indicating whether or not the self-vehicle can travel) as the control input.

### SUMMARY OF THE INVENTION

The present invention provides, for example, technology capable of appropriately identifying a traffic light indicating whether or not a self-vehicle can travel.

According to one aspect of the present invention, there is provided a driving assistance apparatus that assists driving of a vehicle, comprising: an image capturing unit configured to capture an image of the front of the vehicle; an identification unit configured to identify a traffic light in the image obtained by the image capturing unit; a detection unit configured to detect, from the image, an installation height of the traffic light identified by the identification unit; and a determination unit configured to determine whether or not the traffic light identified by the identification unit is a target traffic light indicating whether or not the vehicle travels, based on the installation height detected by the detection unit.

Further features of the present invention will become apparent from the following description of exemplary embodiments with reference to the attached drawings.

### BRIEF DESCRIPTION OF THE DRAWINGS

FIG. 1 is a block diagram of a vehicle and a control device thereof;

FIG. 2 is a block diagram illustrating a configuration example of a driving assistance apparatus;

FIG. 3 is a diagram illustrating an example of a front image obtained by an image capturing unit;

FIG. 4 is a flowchart illustrating driving assistance processing;

FIG. 5 is a flowchart illustrating processing of determining whether or not a traffic light is a target traffic light;

FIG. 6 is a diagram illustrating differences in installation location, installation height, lateral direction distance, and distance from a stop line of a vehicle traffic light for each area;

FIG. 7 is a flowchart illustrating processing of determining whether or not an alarm is necessary; and

FIG. 8 is a diagram illustrating combination information of lighting states.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

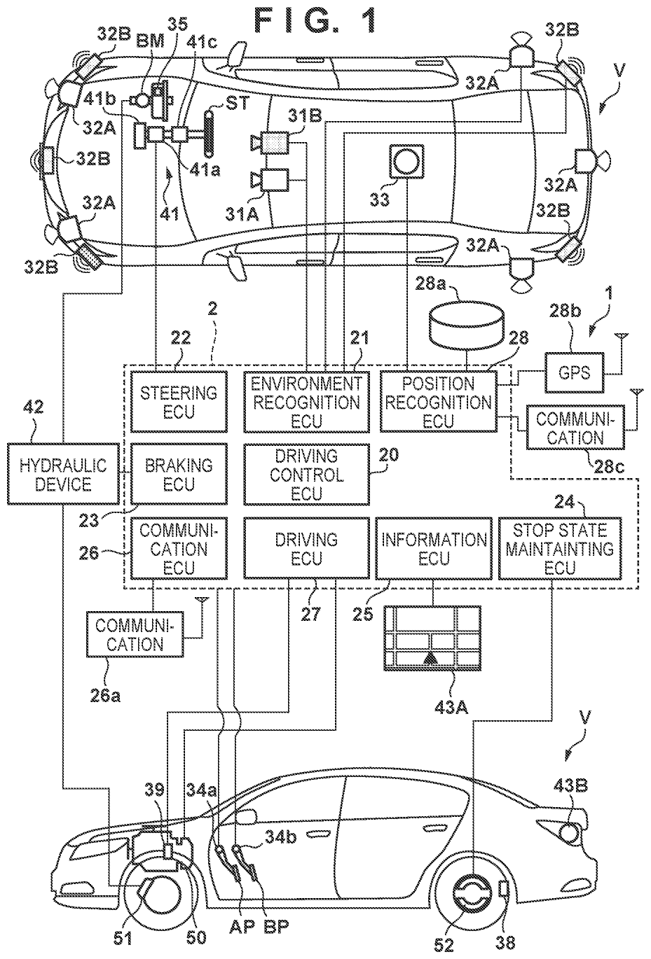

An embodiment according to the present invention will be described. FIG. 1 is a block diagram of a vehicle V and a control device 1 thereof according to the present embodiment. In FIG. 1, an outline of the vehicle V is illustrated in a plan view and in a side view. The vehicle V in the present embodiment is, as an example, a sedan-type four-wheeled passenger vehicle, and may be, for example, a parallel hybrid vehicle. In this case, a power plant 50, which is a traveling driving unit that outputs driving force for rotating driving wheels of the vehicle V, can include an internal combustion engine, a motor, and an automatic transmission. The motor can be used as a driving source for accelerating the vehicle V, and can also be used as a generator at the time of deceleration or the like (regenerative braking). Note that the vehicle V is not limited to the four-wheeled passenger vehicle, and may be a straddle type vehicle (motorcycle or three-wheeled vehicle) or a large vehicle such as a truck or a bus.

### Configuration of Vehicle Control Device

A configuration of the control device 1, which is a device mounted on the vehicle V, will be described with reference to FIG. 1. The control device 1 can include an information processing unit 2 including a plurality of electronic control units (ECUs) 20 to 28 capable of communicating with one another. Each ECU includes a processor represented by a central processing unit (CPU), a storage device such as a semiconductor memory, an interface with an external device, and the like. The storage device stores a program to be executed by the processor, data to be used for processing by the processor, and the like. Each ECU may include a plurality of processors, storage devices, interfaces, and the like. Note that the number of ECUs and functions to be handled can be designed as appropriate, and may be subdivided or integrated, as compared with the present embodiment. For example, the ECUs 20 to 28 may be constituted by one ECU. Note that, in FIG. 1, names of representative functions of the ECUs 20 to 28 are given. For example, the ECU 20 is described as a “driving control ECU”.

The ECU 20 conducts control related to driving control of the vehicle V including driving assistance of the vehicle V. In the case of the present embodiment, the ECU 20 controls driving (acceleration of the vehicle V by the power plant 50 or the like), steering, and braking of the vehicle V. Further, in manual driving, for example, in a case where a lighting state of a target traffic light indicating whether or not the vehicle V can travel is red lighting (red light) or yellow lighting (yellow light), the ECU 20 can execute an alarm for reporting the lighting state to a driver or brake assist of the vehicle V. The alarm can be performed by displaying information on a display device of an information output device 43A to be described later or reporting information by sound or vibration. The brake assist can be performed by controlling a brake device 51.

The ECU 21 is an environment recognition unit that recognizes a traveling environment of the vehicle V, based on detection results of detection units 31A, 31B, 32A, and 32B, which detect surrounding states of the vehicle V. In the case of the present embodiment, the ECU 21 is capable of detecting a position of a target (for example, an obstacle or another vehicle) in the surroundings of the vehicle V, based on a detection result by at least one of the detection units 31A, 31B, 32A, and 32B.

The detection units 31A, 31B, 32A, and 32B are sensors capable of detecting a target in the surroundings of the vehicle V (self-vehicle). The detection units 31A and 31B are cameras that capture images in front of the vehicle V (hereinafter, referred to as the camera 31A and the camera 31B in some cases), and are attached to the vehicle interior side of a windshield on a front part of the roof of the vehicle V. By analyzing the images captured by the camera 31A and the camera 31B, it is possible to extract a contour of a target or extract a division line (white line or the like) between lanes on a road. Although the two cameras 31A and 31B are provided in the vehicle V in the present embodiment, only one camera may be provided.

The detection unit 32A is a light detection and ranging (LiDAR) (hereinafter, referred to as a LiDAR 32A in some cases), detects a target in the surroundings of the vehicle V, and detects (measures) a distance to the target and a direction (azimuth) to the target. In the example illustrated in FIG. 1, five LiDARs 32A are provided, including one at each corner portion of a front part of the vehicle V, one at the center of a rear part of the vehicle V, and one at each lateral side of the rear part of the vehicle V. Note that the LiDAR 32A may not be provided in the vehicle V. In addition, the detection unit 32B is a millimeter-wave radar (hereinafter, referred to as the radar 32B in some cases), detects a target in the surroundings of the vehicle V by use of radio waves, and detects (measures) a distance to the target and a direction (azimuth) to the target. In the example illustrated in FIG. 1, five radars 32B are provided, including one at the center of the front part of the vehicle V, one at each corner portion of the front part of the vehicle V, and one at each corner portion of the rear part of the vehicle V.

The ECU 22 is a steering control unit that controls an electric power steering device 41. The electric power steering device 41 includes a mechanism that steers front wheels in response to a driver's driving operation (steering operation) on a steering wheel ST. The electric power steering device 41 includes a driving unit 41a including a motor that exerts driving force for assisting the steering operation or automatically steering the front wheels (referred to as steering assist torque in some cases), a steering angle sensor 41b, a torque sensor 41c that detects steering torque burdened by the driver (referred to as steering burden torque to be distinguished from steering assist torque), and the like.

The ECU 23 is a braking control unit that controls a hydraulic device 42. The driver's braking operation on a brake pedal BP is converted into hydraulic pressure in a brake master cylinder BM, and is transmitted to the hydraulic device 42. The hydraulic device 42 is an actuator capable of controlling the hydraulic pressure of hydraulic oil to be supplied to the brake device (for example, a disc brake device) 51 provided on each of the four wheels, based on the hydraulic pressure transmitted from the brake master cylinder BM, and the ECU 23 controls the driving of an electromagnetic valve and the like included in the hydraulic device 42. The ECU 23 is also capable of turning on brake lamps 43B at the time of braking. As a result, it is possible to enhance attention to the vehicle V with respect to a following vehicle.

The ECU 23 and the hydraulic device 42 are capable of constituting an electric servo brake. The ECU 23 is capable of controlling, for example, the distribution of the braking force by the four brake devices 51 and the braking force by the regenerative braking of the motor included in the power plant 50. The ECU 23 is also capable of achieving an ABS function, traction control, and a posture control function of the vehicle V, based on detection results of wheel speed sensors 38 provided for the respective four wheels, a yaw rate sensor (not illustrated in the drawings), and a pressure sensor 35 for detecting the pressure in the brake master cylinder BM.

The ECU 24 is a stop-state maintaining control unit that controls electric parking brake devices 52 provided on the rear wheels. The electric parking brake devices 52 each include a mechanism for locking the rear wheel. The ECU 24 is capable of controlling locking and unlocking of the rear wheels by the electric parking brake devices 52.

The ECU 25 is an in-vehicle report control unit that controls the information output device 43A, which reports information to the vehicle inside. The information output device 43A includes, for example, a display device provided on a head-up display or an instrument panel, or a sound output device. A vibration device may additionally be included. The ECU 25 causes the information output device 43A to output, for example, various types of information such as a vehicle speed and an outside air temperature, information such as route guidance, and information regarding a state of the vehicle V.

The ECU 26 includes a communication device 26a, which performs wireless communication. The communication device 26a is capable of exchanging information by wireless communication with a target having a communication function. Examples of the target having a communication function include a vehicle (vehicle-to-vehicle communication), a fixed facility such as a traffic light or a traffic monitor (road-to-vehicle communication), and a person (pedestrian or bicycle) carrying a mobile terminal such as a smartphone. In addition, by accessing a server or the like on the Internet through the communication device 26a, the ECU 26 is capable of acquiring various types of information such as road information.

The ECU 27 is a driving control unit that controls the power plant 50. In the present embodiment, one ECU 27 is assigned to the power plant 50, but one ECU may be assigned to each the internal combustion engine, the motor, and the automatic transmission. The ECU 27 controls the output of the internal combustion engine or the motor, or switches a gear ratio of the automatic transmission in accordance with, for example, a driver's driving operation or a vehicle speed detected by an operation detection sensor 34a provided on an accelerator pedal AP or an operation detection sensor 34b provided on the brake pedal BP. Note that the automatic transmission includes a rotation speed sensor 39, which detects the rotation speed of an output shaft of the automatic transmission, as a sensor for detecting a traveling state of the vehicle V. The vehicle speed of the vehicle V can be calculated from a detection result of the rotation speed sensor 39.

The ECU 28 is a position recognition unit that recognizes a current position and a course of the vehicle V. The ECU 28 controls a gyro sensor 33, a global positioning system (GPS) sensor 28b, and a communication device 28c, and performs information processing on a detection result or a communication result. The gyro sensor 33 detects a rotational motion (yaw rate) of the vehicle V. It is possible to determine the course of the vehicle V from the detection result or the like of the gyro sensor 33. The GPS sensor 28b detects the current position of the vehicle V. The communication device 28c performs wireless communication with a server that provides map information and traffic information, and acquires these pieces of information. Since the map information with high accuracy can be stored in a database 28a, the ECU 28 is capable of identifying the position of the vehicle Von a lane, based on such map information or the like. In addition, the vehicle V may include a speed sensor for detecting the speed of the vehicle V, an acceleration sensor for detecting the acceleration of the vehicle V, and a lateral acceleration sensor (lateral G sensor) for detecting the lateral acceleration of the vehicle V.

### Configuration of Driving Assistance Apparatus

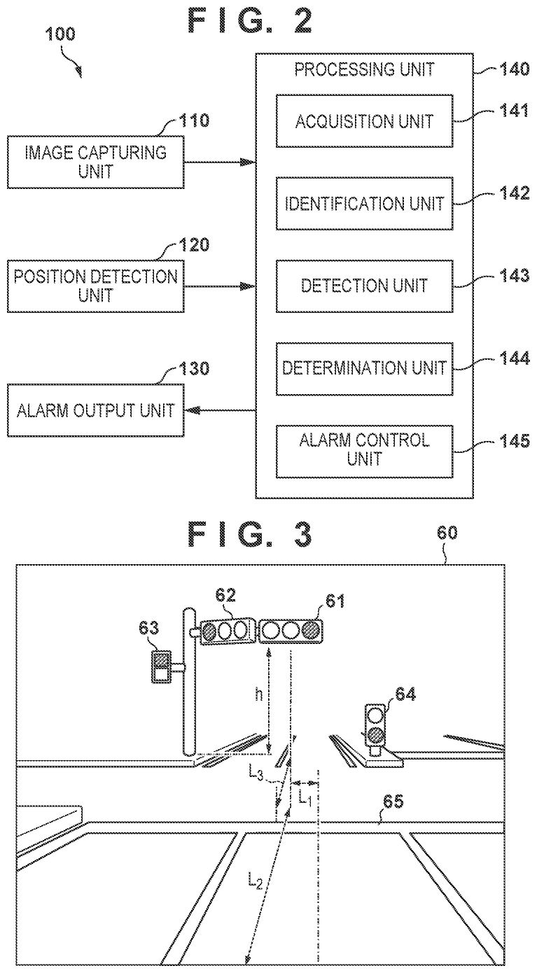

FIG. 2 is a block diagram illustrating a configuration example of a driving assistance apparatus 100 according to the present embodiment. The driving assistance apparatus 100 is a device for assisting driving of the vehicle V by the driver, and may include, for example, an image capturing unit 110, a position detection unit 120, an alarm output unit 130, and a processing unit 140. The image capturing unit 110, the position detection unit 120, the alarm output unit 130, and the processing unit 140 are communicably connected to one another via a system bus.

The image capturing unit 110 is, for example, the cameras 31A and 31B illustrated in FIG. 1, and captures an image of the front of the vehicle V. The position detection unit 120 is, for example, the GPS sensor 28b illustrated in FIG. 1, and detects a current position and a traveling direction of the vehicle V. The position detection unit 120 may include the gyro sensor 33, in addition to the GPS sensor 28b. Further, the alarm output unit 130 is, for example, the information output device 43A illustrated in FIG. 1, and reports various types of information to an occupant (for example, the driver) of the vehicle by displaying on a display, a sound output, or the like. In the present embodiment, in a case where the lighting state of the target traffic light indicating whether or not the vehicle V can travel is red lighting (red light) or yellow lighting (yellow light), the alarm output unit 130 can be used to output an alarm for reporting the lighting state to the driver.

The processing unit 140 is constituted by a computer including a processor represented by a central processing unit (CPU), a storage device such as a semiconductor memory, an interface with an external device, and the like, and can function as a part of the ECU of the information processing unit 2 illustrated in FIG. 1. In the storage device, a program for providing driving assistance (driving assistance program) for the driver of the vehicle V is stored, and the processing unit 140 can read and execute the driving assistance program stored in the storage device. The processing unit 140 of the present embodiment can be provided with an acquisition unit 141, an identification unit 142, a detection unit 143, a determination unit 144, and an alarm control unit 145.

The acquisition unit 141 acquires various types of information from a sensor or the like provided in the vehicle. In the case of the present embodiment, the acquisition unit 141 acquires the image obtained by the image capturing unit 110 and the position information (current position information) of the vehicle V obtained by the position detection unit 120. The identification unit 142 identifies a traffic light included in the image by performing image processing on the image obtained by the image capturing unit 110. The detection unit 143 performs image processing on the image obtained by the image capturing unit 110 to detect (calculate), from the image, the installation height or the like of the traffic light identified by the identification unit 142. In the present embodiment, the installation height of the traffic light can be defined as the height of the traffic light with reference to the road surface on which the traffic light is installed, that is, the height from the road surface (the root of the pillar of the traffic light) at the place where the traffic light is installed to the traffic light.

Based on the installation height detected by the detection unit 143, the determination unit 144 determines whether or not the traffic light identified by the identification unit 142 is a traffic light provided on the traveling road of the vehicle V and indicating whether or not the vehicle V can travel (hereinafter, referred to as a target traffic light in some cases). In a case where the determination unit 144 determines that the traffic light identified by the identification unit 142 is the target traffic light, the alarm control unit 145 determines whether or not an alarm is necessary for the driver of the vehicle V based on the lighting state of the target traffic light. Then, when it is determined that the alarm is necessary, the alarm output unit 130 is controlled to output an alarm to the driver of the vehicle V.

Incidentally, the image obtained by the image capturing unit 110 may include, in addition to a traffic light (target traffic light) indicating whether or not the vehicle V can travel, an intersection road traffic light provided on an intersection road intersecting with the traveling road of the vehicle V, a pedestrian traffic light, a blinker light, and the like. FIG. 3 illustrates an example (front image 60) of the image obtained by the image capturing unit 110. A front image 60 illustrated in FIG. 3 is an image obtained by the image capturing unit 110 when the vehicle V approaches an intersection, and the front image 60 includes an intersection road traffic light 62, a pedestrian traffic light 63, and a blinker light 64, in addition to the target traffic light 61. Further, the front image 60 includes a stop line 65 where the vehicle V should stop. Since the intersection road traffic light 62, the pedestrian traffic light 63, the blinker light 64, and the like have a structure similar to that of the target traffic light 61, they may be erroneously determined as the target traffic light 61. Therefore, it is necessary to appropriately distinguish and recognize the target traffic light 61 with respect to the intersection road traffic light 62, the pedestrian traffic light 63, the blinker light 64, and the like, and such technology is required. In particular, technology for appropriately distinguishing and recognizing the pedestrian traffic light 63 and the blinker light 64 from the target traffic light 61 is required.

Therefore, as described above, the driving assistance apparatus 100 (processing unit 140) of the present embodiment is provided with the detection unit 143 that detects the installation height of the traffic light identified by the identification unit 142, and the determination unit 144 that determines whether or not the traffic light identified by the identification unit 142 is the target traffic light based on the installation height detected by the detection unit 143. Since the pedestrian traffic light 63 and the blinker light 64 have lower installation heights than the vehicle traffic light, according to the driving assistance apparatus 100 of the present embodiment, it is possible to appropriately distinguish and recognize the target traffic light 61 with respect to the pedestrian traffic light 63 and the blinker light 64.

### Driving Assistance Processing

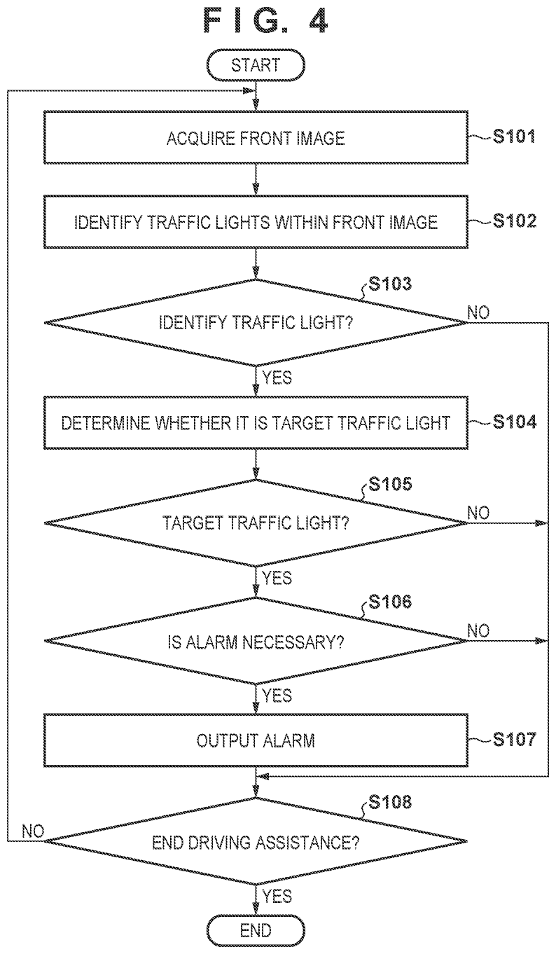

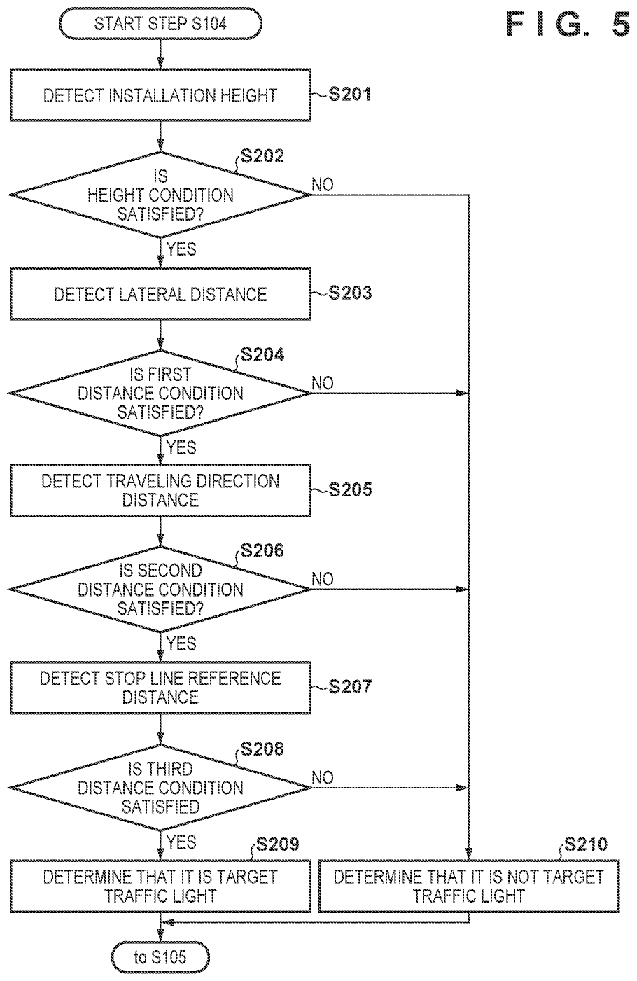

Hereinafter, driving assistance processing according to the present embodiment will be described. FIG. 4 is a flowchart illustrating the driving assistance processing according to the present embodiment. The driving assistance processing illustrated in the flowchart of FIG. 4 is processing executed by the processing unit 140 when a driving assistance program is executed in the driving assistance apparatus 100.

In step S101, the processing unit 140 (acquisition unit 141) acquires, from the image capturing unit 110, an image (front image) obtained by imaging the front of the vehicle V by the image capturing unit 110. Next, in step S102, the processing unit 140 (identification unit 142) identifies traffic lights included in the front image by performing image processing on the front image obtained in step S101. For example, the identification unit 142 can identify all traffic lights included in the front image by extracting a portion emitting blue (green), yellow, or red light in the front image. Here, as the image processing performed by the identification unit 142, known image processing may be used. Further, the traffic lights identified by the identification unit 142 include a pedestrian traffic light and a blinker light, in addition to the vehicle traffic light. In the example of FIG. 3, the identification unit 142 identifies the vehicle traffic lights 61 and 62, the pedestrian traffic light 63, and the blinker light 64 in the front image 60.

In step S103, the processing unit 140 determines whether or not the traffic light has been identified in the front image in step S102. When the traffic light is not identified in the front image, the process proceeds to step S108, and when the traffic light is identified in the front image, the process proceeds to step S104. In step S104, the processing unit 140 (the detection unit 143 and the determination unit 144) determines whether or not the traffic light identified in step S102 is a target traffic light indicating whether or not the vehicle V (self-vehicle) can travel. Specific processing contents performed in step S104 will be described later. Next, in step S105, the processing unit 140 determines whether or not the traffic light has been determined as the target traffic light in step S104. When the traffic light is not determined as the target traffic light, the process proceeds to step S108, and when the traffic light is determined as the target traffic light, the process proceeds to step S106.

In step S106, the processing unit 140 (the determination unit 144 and the alarm control unit 145) determines whether or not an alarm to the driver is necessary based on a lighting state of the target traffic light. Specific processing contents performed in step S106 will be described later. When it is determined that the alarm is not necessary, the process proceeds to step S108, and when it is determined that the alarm is necessary, the process proceeds to step S107. In step S107, the processing unit (alarm control unit 145) outputs the alarm to the driver by controlling the alarm output unit 130. In the present embodiment, an example in which the alarm is output to the driver is illustrated, but brake assist may be executed in addition to the alarm or instead of the alarm.

In step S108, the processing unit 140 determines whether or not to end the driving assistance of the vehicle V. For example, when the driver turns off the driving assistance of the vehicle V, or when the ignition of the vehicle V is turned off, the processing unit 140 is capable of determining that the driving assistance of the vehicle V ends. When the driving assistance of the vehicle V does not end, the process returns to step S101.

### Processing of Determining whether or Not Traffic Light is Target Traffic Light (S104)

Next, specific processing contents of “processing of determining whether or not the traffic light is the target traffic light” performed in step S104 in FIG. 4 will be described with reference to FIG. 5. FIG. 5 is a flowchart illustrating processing contents performed by the processing unit 140 (the detection unit 143 and the determination unit 144) in step S104 of FIG. 4.

In step S201, the processing unit 140 (detection unit 143) detects (calculates) the installation height of the traffic light identified in step S102 from the front image. As described above, the installation height is defined as the height of the traffic light with reference to the road surface on which the traffic light is installed, and is written as “h” in FIG. 3. The detection unit 143 can detect the installation height of each traffic light identified in step S102 by performing known image processing on the front image.

Here, for example, there is a case where there is a gradient (slope) between the road surface on which the vehicle V is located and the road surface on which the traffic light is installed, and the road surface on which the traffic light is installed (the root of the pillar of the traffic light) is not included in the front image. In this case, it may be difficult to accurately detect (calculate) the installation height of the traffic light from the front image. Therefore, the detection unit 143 may obtain the installation height of the traffic light by calculating the height of the traffic light with reference to the vehicle V from the front image, and correcting the height of the traffic light with reference to the vehicle calculated from the front image based on height difference information indicating the height difference between the road surface on which the vehicle V is located and the road surface on which the traffic light is installed. The height difference information is included in map information stored in the database 28a, for example, and can be acquired from the database 28a via the acquisition unit 141. The detection unit 143 can obtain the height difference information from the map information acquired by the acquisition unit 141, based on the current position of the vehicle V detected by the position detection unit 120 (GPS sensor 28b). Note that the height difference information may be acquired from an external server via the acquisition unit 141 and the communication device 28c, based on the current position of the vehicle V detected by the position detection unit 120.

In step S202, the processing unit 140 (determination unit 144) determines whether or not the installation height detected in step S201 satisfies a predetermined condition (height condition) related to the installation height of the vehicle traffic light (target traffic light). For example, the determination unit 144 can determine whether or not the height condition is satisfied based on whether or not the installation height detected in step S201 falls within a predetermined range. When the installation height does not satisfy the height condition, the process proceeds to step S210, and it is determined that the traffic light identified in step S102 is not the target traffic light. On the other hand, when the installation height satisfies the height condition, the process proceeds to step S203. By step S202, it is possible to appropriately distinguish and recognize whether the traffic light identified in step S102 is a vehicle traffic light, a pedestrian traffic light, or a blinker light.

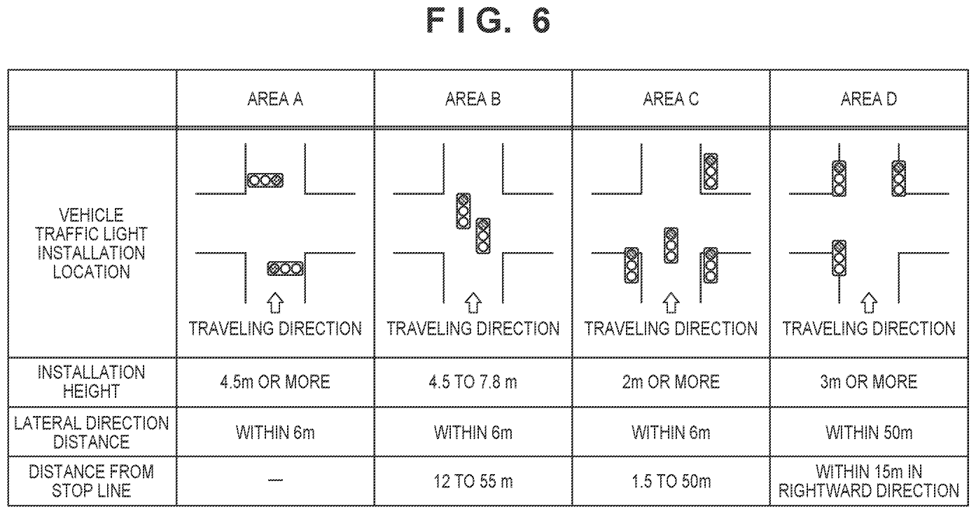

Here, the installation height of the vehicle traffic light is different for each area (for example, for each country). FIG. 6 illustrates differences in installation location, installation height, lateral direction distance, and distance from the stop line of the vehicle traffic light for each area. In FIG. 6, it can be seen that areas A to D are illustrated, and the installation height of the vehicle traffic light is different for each area. Therefore, the determination unit 144 may change the height condition (that is, the range of the installation height for determining that the traffic light is the target traffic light) according to an area where the vehicle V travels. Specifically, the determination unit 144 identifies an area (for example, a country) where the vehicle V travels based on the current position of the vehicle V detected by the position detection unit 120, and changes the height condition according to the identified area. Information indicating the height condition for each area may be stored in, for example, the database 28a or the memory of the processing unit 140, or may be acquired from an external server via the acquisition unit 141 and the communication device 28c.

In step S203, the processing unit 140 (detection unit 143) detects (calculates) the lateral direction distance between the traffic light identified in step S102 and the vehicle V from the front image. The lateral direction distance is defined as a lateral direction distance between a representative position (for example, a center position) of the traffic light and a representative position (for example, a center position) of the vehicle V, and is written as “L1” in FIG. 3. The lateral direction may be understood as a vehicle width direction of the vehicle V. The detection unit 143 can detect the lateral direction distance of each traffic light identified in step S102 by performing known image processing on the front image.

In step S204, the processing unit 140 (determination unit 144) determines whether or not the lateral direction distance detected in step S203 satisfies a predetermined condition (first distance condition) related to the lateral direction distance of the target traffic light. For example, the determination unit 144 can determine whether or not the first distance condition is satisfied based on whether or not the lateral direction distance detected in step S203 falls within a predetermined range. When the lateral direction distance does not satisfy the first distance condition, the process proceeds to step S210, and it is determined that the traffic light identified in step S102 is not the target traffic light. On the other hand, when the lateral direction distance satisfies the first distance condition, the process proceeds to step S205. By step S204, it is possible to appropriately distinguish and recognize whether the traffic light identified in step S102 is the target traffic light indicating whether or not the vehicle V can travel or not, or the intersection road traffic light.

Here, as illustrated in FIG. 6, the lateral direction distance of the target traffic light is different for each area (for example, for each country). Therefore, the determination unit 144 may change the first distance condition (that is, the range of the lateral direction distance for determining that the traffic light is the target traffic light) according to the area where the vehicle V travels. Specifically, similarly to the height condition, the determination unit 144 identifies an area (for example, a country) where the vehicle V travels based on the current position of the vehicle V detected by the position detection unit 120, and changes the first distance condition according to the identified area. Information indicating the first distance condition for each area may be stored in, for example, the database 28a or the memory of the processing unit 140, or may be acquired from an external server via the acquisition unit 141 and the communication device 28c.

In step S205, the processing unit 140 (detection unit 143) detects (calculates) a traveling direction distance between the traffic light identified in step S102 and the vehicle V from the front image. The traveling direction distance is defined as a distance in the traveling direction between a representative position (for example, a center position) of the traffic light and a representative position (for example, a center position) of the vehicle V, and is written as “L2” in FIG. 3. The traveling direction may be understood as a front-and-rear direction of the vehicle V. The detection unit 143 can detect the traveling direction distance of each traffic light identified in step S102 by performing known image processing on the front image.

In step S206, the processing unit 140 (determination unit 144) determines whether or not the traveling direction distance detected in step S205 satisfies a predetermined condition (second distance condition) related to the traveling direction distance of the target traffic light. For example, the determination unit 144 can determine whether or not the second distance condition is satisfied based on whether or not the traveling direction distance detected in step S205 falls within a predetermined range. When the traveling direction distance does not satisfy the second distance condition, the process proceeds to step S210, and it is determined that the traffic light identified in step S102 is not the target traffic light. On the other hand, when the traveling direction distance satisfies the second distance condition, the process proceeds to step S207. By step S206, it is possible to appropriately distinguish and recognize whether the traffic light identified in step S102 is a traffic light installed at an intersection where the vehicle V is located, or a traffic light installed at an intersection ahead of the intersection where the vehicle V is located.

In step S207, the processing unit 140 (detection unit 143) detects a stop line provided in a traveling lane of the vehicle V from the front image, and detects the traffic light identified in step S102 and the distance from the traffic light (hereinafter, referred to as a stop line reference distance in some cases). The stop line reference distance may be defined as a traveling direction distance between a representative position (for example, a center position) of the traffic light and a representative position (for example, a center position) of the stop line. In FIG. 3, the stop line 65 provided in the traveling lane of the vehicle V is illustrated, and the stop line reference distance is written as “L3”. The detection unit 143 can detect the stop line and the stop line reference distance of each traffic light identified in step S102 by performing known image processing on the front image.

In step S208, the processing unit 140 (determination unit 144) determines whether or not the stop line reference distance detected in step S207 satisfies a predetermined condition (third distance condition) related to the stop line reference distance of the target traffic light. For example, the determination unit 144 can determine whether or not the third distance condition is satisfied based on whether or not the stop line reference distance detected in step S207 falls within a predetermined range. When the stop line reference distance does not satisfy the third distance condition, the process proceeds to step S210, and it is determined that the traffic light identified in step S102 is not the target traffic light. On the other hand, when the stop line reference distance satisfies the third distance condition, the process proceeds to step S209, and it is determined that the traffic light identified in step S102 is the target traffic light. By step S208, it is possible to more appropriately distinguish and recognize whether the traffic light identified in step S102 is the target traffic light indicating whether or not the vehicle V can travel, or the intersection road traffic light.

Here, as illustrated in FIG. 6, the stop line reference distance of the target traffic light is different for each area (for example, for each country). Therefore, the determination unit 144 may change the third distance condition (that is, the range of the stop line reference distance for determining that the traffic light is the target traffic light) according to the area where the vehicle V travels. Specifically, similarly to the height condition or the first distance condition, the determination unit 144 identifies an area (for example, a country) where the vehicle V travels based on the current position of the vehicle V detected by the position detection unit 120, and changes the third distance condition according to the identified area. Information indicating the third distance condition for each area may be stored in, for example, the database 28a or the memory of the processing unit 140, or may be acquired from an external server via the acquisition unit 141 and the communication device 28c.

In the above, an example has been described in which whether or not the traffic light is the target traffic light is determined based on the installation height, the lateral direction distance, the traveling direction distance, and the stop line reference distance of the traffic light in the front image. However, the determination is not limited to the above, and may be made only based on the installation height of the traffic light, or may be made based on at least one of the lateral direction distance, the traveling direction distance, and the stop line reference distance in addition to the installation height.

### Processing of Determining whether or Not Alarm is Necessary (S106)

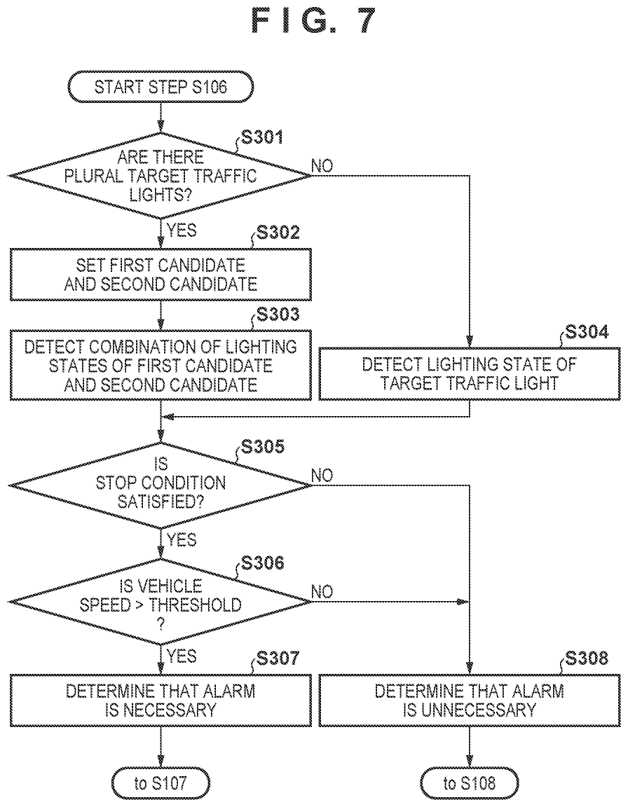

Next, specific processing contents of the “processing of determining whether or not an alarm is necessary” performed in step S106 in FIG. 4 will be described with reference to FIG. 7. FIG. 7 is a flowchart illustrating processing contents performed by the processing unit 140 (the determination unit 144 and the alarm control unit 145) in step S106 of FIG. 4.

In step S301, the processing unit 140 (determination unit 144) determines whether or not there are a plurality of target traffic lights. That is, when the plurality of traffic lights are identified in step S102, the alarm control unit 145 determines whether or not there are a plurality of traffic lights determined as the target traffic light in step S104 among the plurality of traffic lights. When there are the plurality of target traffic lights, the process proceeds to step S302. On the other hand, when there are not the plurality of target traffic lights (that is, when there is one traffic light determined as the target traffic light in step S104), the process proceeds to step S304.

First, a case where it is determined in step S301 that there are the plurality of target traffic lights will be described. In this case, steps S302 and S303, and S305 are executed.

In step S302, the processing unit 140 (determination unit 144) sets a first candidate and a second candidate for the target traffic light from among the plurality of traffic lights determined as the target traffic light in step S104. For example, the determination unit 144 sets (determines), as the first candidate for the target traffic light, a traffic light whose installation height satisfies the height condition and whose lateral direction distance is shortest among the plurality of traffic lights determined as the target traffic light in step S104, based on the detection result of the detection unit 143. In addition, the determination unit 144 sets (determines), as the second candidate for the target traffic light, a traffic light whose installation height satisfies the height condition and whose traveling direction distance is shortest among the plurality of traffic lights determined as the target traffic light in step S104, based on the detection result of the detection unit 143. In the example of FIG. 3, since the traffic light 61 is a traffic light whose installation height h satisfies the height condition and whose lateral direction distance L1 is shortest, the traffic light 61 can be set as the first candidate for the target traffic light. In addition, since the traffic light 62 is a traffic light whose installation height h satisfies the height condition and whose traveling direction distance L2 is shortest, the traffic light 62 can be set as the second candidate for the target traffic light. Note that the “detection result of the detection unit 143” used in step S302 is a result detected (calculated) in step S104, and includes at least the installation height, the lateral direction distance, and the traveling direction distance.

In step S303, the processing unit 140 (alarm control unit 145) detects a combination of lighting states of the first candidate traffic light (traffic light 61 in the example of FIG. 3) and the second candidate traffic light (traffic light 62 in the example of FIG. 3). For example, the alarm control unit 145 performs known image processing on the front image acquired in step S101, and detects whether the lighting state is blue lighting (green light), yellow lighting (yellow light), or red lighting (red light) for each of the first candidate traffic light and the second candidate traffic light in the front image. As a result, a combination of the lighting states of the first candidate traffic light and the second candidate traffic light can be obtained.

In step S305, the processing unit 140 (alarm control unit 145) determines whether or not the combination of the lighting states detected in step S303 satisfies the stop condition. The stop condition is a condition under which the vehicle V should be stopped at an intersection in front of the vehicle V. When the combination of the lighting states satisfies the stop condition, the process proceeds to step S306, and when the combination of the lighting states does not satisfy the stop condition, the process proceeds to step S308.

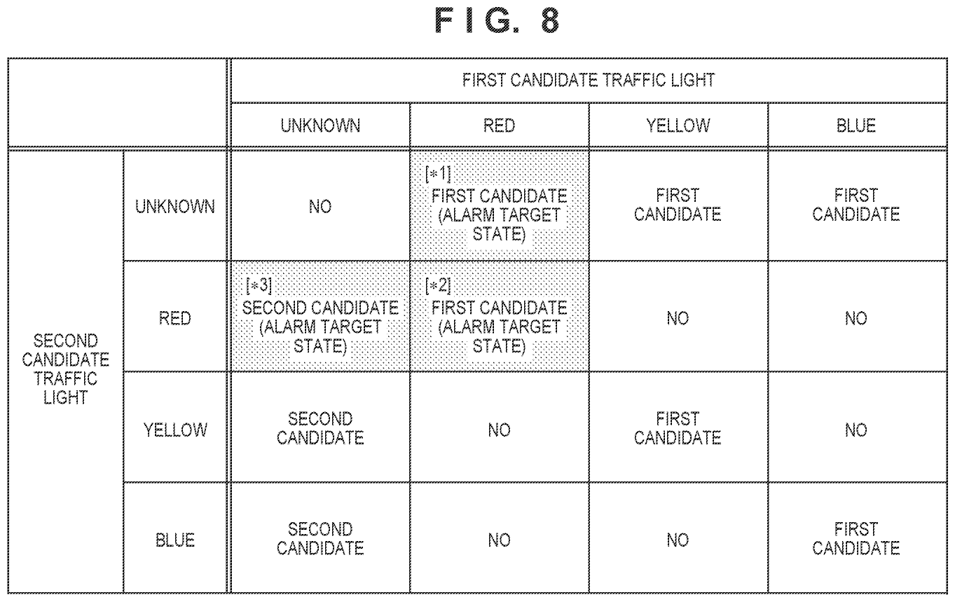

For example, the alarm control unit 145 can determine whether or not the combination of the lighting states detected in step S303 satisfies the stop condition, based on the combination information illustrated in FIG. 8. The combination information illustrated in FIG. 8 is information for determining which one of the first candidate traffic light and the second candidate traffic light is applied as the target traffic light according to the combination of the lighting states of the first candidate traffic light and the second candidate traffic light. As an example, when the lighting state of the first candidate traffic light is red lighting and the lighting state of the second candidate traffic light is unknown (case of [*1]), the first candidate traffic light is applied as the target traffic light. Even when the lighting state of the first candidate traffic light is red lighting and the lighting state of the second candidate traffic light is red lighting (case of [*2]), the first candidate traffic light is applied as the target traffic light. On the other hand, when the lighting state of the first candidate traffic light is unknown and the lighting state of the second candidate traffic light is red lighting (case of [*3]), the second candidate traffic light is applied as the target traffic light. The above cases (cases of [*1] to [*3]) are a combination of the lighting states that satisfy the stop condition, and are a state in which there is a high possibility that an alarm is required for the driver (alarm target state). That is, the stop condition is satisfied when the combination of the lighting states detected in step S303 corresponds to any of [*1] to [*3].

Next, a case where it is determined in step S301 that there are not a plurality of target traffic lights (that is, there is one target traffic light) will be described. In this case, steps S304 and S305 are executed.

In step S304, the processing unit 140 (alarm control unit 145) detects the lighting state of the traffic light determined as the target traffic light in step S104. For example, the alarm control unit 145 performs known image processing on the front image acquired in step S101, and detects whether the lighting state of the target traffic light in the front image is blue lighting (green light), yellow lighting (yellow light), or red lighting (red light). Next, in step S305, the processing unit 140 (alarm control unit 145) determines whether or not the lighting state of the target traffic light detected in step S304 satisfies the stop condition. For example, the alarm control unit 145 determines that the stop condition is satisfied when the lighting state of the target traffic light detected in step S304 is red lighting or yellow lighting. When the lighting state of the target traffic light satisfies the stop condition, the process proceeds to step S306, and when the lighting state of the target traffic light does not satisfy the stop condition, the process proceeds to step S308.

In step S306, the processing unit 140 (alarm control unit 145) acquires the speed (vehicle speed) of the vehicle V from the speed sensor via the acquisition unit 141, and determines whether or not the vehicle speed exceeds a threshold. When the vehicle speed exceeds the threshold, there is a high possibility that the driver is not aware of the lighting state (red lighting or yellow lighting) of the target traffic light. Therefore, the alarm control unit 145 determines that an alarm for the driver is necessary in step S307, and then proceeds to step S107 in FIG. 4. On the other hand, when the vehicle speed does not exceed the threshold, there is a high possibility that the driver is aware of the lighting state of the target traffic light and is trying to stop the vehicle V. Therefore, the alarm control unit 145 determines that the alarm for the driver is unnecessary in step S308, and then proceeds to step S108 in FIG. 4. Note that the threshold of the vehicle speed can be arbitrarily set, and for example, it can be set to a speed (for example, 5 to 20 km/h) that can be determined as the driver's stop intention.

As described above, the driving assistance apparatus 100 of the present embodiment detects the installation height of the traffic light identified from the front image obtained by the image capturing unit 110, and determines whether or not the traffic light is the target traffic light indicating whether or not the vehicle V can travel based on the installation height. As a result, even when the front image includes the pedestrian traffic light, the blinker light, and the like, it is possible to appropriately distinguish and recognize (determine) the target traffic light with respect to the pedestrian traffic light, the blinker light, and the like.

### Other Embodiments

In addition, a program for achieving one or more functions that have been described in the above embodiment is supplied to a system or an apparatus through a network or a storage medium, and one or more processors in a computer of the system or the apparatus are capable of reading and executing the program. The present invention is also achievable by such an aspect.

### Summary of Embodiments

1. A driving assistance apparatus of the above-described embodiment is a driving assistance apparatus (e.g. 100) that assists driving of a vehicle (e.g. V), comprising:

an image capturing unit (e.g. 110) configured to capture an image of the front of the vehicle;

an identification unit (e.g. 142) configured to identify a traffic light (e.g. 61 to 64) in the image (e.g. 60) obtained by the image capturing unit;

a detection unit (e.g. 143) configured to detect, from the image, an installation height (e.g. h) of the traffic light identified by the identification unit; and

a determination unit (e.g. 144) configured to determine whether or not the traffic light identified by the identification unit is a target traffic light indicating whether or not the vehicle travels, based on the installation height detected by the detection unit.

According to this embodiment, even when the pedestrian traffic light, the blinker light, and the like are included in the image obtained by the image capturing unit, it is possible to appropriately distinguish and recognize (determine) the target traffic light indicating whether or not the vehicle can travel with respect to the pedestrian traffic light, the blinker light, and the like.

2. In the above-described embodiment,

the determination unit is configured to determine that the traffic light identified by the identification unit is the target traffic light, in a case where the installation height detected by the detection unit satisfies a predetermined condition.

According to this embodiment, the target traffic light can be appropriately recognized from the image obtained by the image capturing unit.

3. In the above-described embodiment,

the determination unit is configured to change the predetermined condition according to an area where the vehicle travels.

According to this embodiment, since the predetermined condition related to the installation height can be changed for each area where the installation height of the vehicle traffic light is different, the target traffic light can be appropriately recognized from the image obtained by the image capturing unit according to the area.

4. In the above-described embodiment,

the detection unit is configured to detect, as the installation height, a height of the traffic light with reference to a road surface on which the traffic light is installed.

According to this embodiment, since the installation height of each traffic light identified from the image obtained by the image capturing unit can be detected using the same reference, the target traffic light can be appropriately recognized from the image.

5. In the above-described embodiment,

the detection unit is configured to detect the installation height by calculating a height of the traffic light with reference to the vehicle from the image, and correcting the height of the traffic light calculated from the image based on information indicating a height difference between a road surface on which the vehicle is located and a road surface on which the traffic light is installed.

According to this embodiment, even when there is a gradient (slope) between the road surface on which the vehicle is located and the road surface on which the traffic light is installed, and the road surface on which the traffic light is installed (the root of the pillar of the traffic light) is not included in the image, the installation height of the traffic light can be accurately detected (calculated).

6. In the above-described embodiment,

the detection unit is configured to detect, from the image, a distance (e.g. L3) between the traffic light identified by the identification unit and a stop line (e.g. 65) provided in a traveling lane of the vehicle, and

the determination unit is configured to determine whether or not the traffic light identified by the identification unit is the target traffic light based further on the distance between the traffic light identified by the identification unit and the stop line.

According to this embodiment, it is possible to appropriately distinguish and recognize whether the traffic light identified from the image is the target traffic light indicating whether or not the vehicle can travel, or an intersection road traffic light.

7. In the above-described embodiment,

the detection unit is configured to detect, from the image, a lateral direction distance (e.g. L1) between the traffic light identified by the identification unit and the vehicle, and

the determination unit is configured to determine whether or not the traffic light identified by the identification unit is the target traffic light based further on the lateral direction distance detected by the detection unit.

According to this embodiment, it is possible to appropriately distinguish and recognize whether the traffic light identified from the image is the target traffic light indicating whether or not the vehicle can travel, or an intersection road traffic light.

8. In the above-described embodiment,

the detection unit is configured to detect, from the image, a traveling direction distance (e.g. L2) between the traffic light identified by the identification unit and the vehicle, and

the determination unit is configured to determine whether or not the traffic light identified by the identification unit is the target traffic light based further on the traveling direction distance detected by the detection unit.

According to this embodiment, it is possible to appropriately distinguish and recognize whether the traffic light identified from the image is a traffic light installed at an intersection where the vehicle is located, or a traffic light installed at an intersection ahead of the intersection where the vehicle is located.

9. In the above-described embodiment,

the driving assistance apparatus further comprises: an alarm control unit (e.g. 130 and 145) configured to output an alarm to a driver according to a lighting state of the target traffic light, in a case where the determination unit determines that the traffic light identified by the identification unit is the target traffic light.

According to this embodiment, since it is possible to appropriately notify the driver of the lighting state of the target traffic light, it is possible to improve the safety of the vehicle.

10. In the above-described embodiment,

the alarm control unit is configured to determine to output the alarm in a case where a lighting state of the target traffic light is red lighting or yellow lighting and a speed of the vehicle exceeds a threshold.

According to this embodiment, when the speed of the vehicle exceeds the threshold, there is a high possibility that the driver is not aware of the lighting state (red lighting or yellow lighting) of the target traffic light. Therefore, it is possible to appropriately notify the driver of the lighting state and to improve the safety of the vehicle.

11. In the above-described embodiment,

in a case where a plurality of traffic lights are identified by the identification unit,

the detection unit is configured to detect, from the image, the installation height (e.g. h), a lateral direction distance (e.g. L1) from the vehicle, and a traveling direction (e.g. L2) distance from the vehicle for each of the plurality of traffic lights,

the determination unit is configured to
determine, as a first candidate for the target traffic light, a traffic light that has the installation height satisfying a predetermined condition and the shortest lateral direction distance among the plurality of traffic lights, based on a detection result by the detection unit, and
determine, as a second candidate for the target traffic light, a traffic light that has the installation height satisfying the predetermined condition and the shortest traveling direction distance among the plurality of traffic lights, based on a detection result by the detection unit, and

the alarm control unit is configured to determine whether or not to output the alarm according to a combination of a lighting state of the first candidate traffic light and a lighting state of the second candidate traffic light.

According to this embodiment, when a plurality of traffic lights are identified from the image, a plurality of candidates related to the target traffic light are set, and whether or not an alarm is output is determined according to a combination of lighting states of the plurality of candidates, so that it is possible to accurately determine whether or not the vehicle can travel and appropriately notify the driver of the alarm. That is, the safety of the vehicle can be improved.

The invention is not limited to the foregoing embodiments, and various variations/changes are possible within the spirit of the invention.

What is claimed is:

1. A driving assistance apparatus that assists driving of a vehicle, comprising:
an image capturing unit configured to capture an image of the front of the vehicle;
an identification unit configured to identify a traffic light in the image obtained by the image capturing unit;
a detection unit configured to detect, from the image, an installation height of the traffic light identified by the identification unit; and
a determination unit configured to determine whether or not the traffic light identified by the identification unit is a target traffic light indicating whether or not the vehicle travels, based on the installation height detected by the detection unit.

2. The driving assistance apparatus according to claim 1, wherein the determination unit is configured to determine that the traffic light identified by the identification unit is the target traffic light, in a case where the installation height detected by the detection unit satisfies a predetermined condition.

3. The driving assistance apparatus according to claim 2, wherein the determination unit is configured to change the predetermined condition according to an area where the vehicle travels.

4. The driving assistance apparatus according to claim 1, wherein the detection unit is configured to detect, as the installation height, a height of the traffic light with reference to a road surface on which the traffic light is installed.

5. The driving assistance apparatus according to claim 4, wherein the detection unit is configured to detect the installation height by calculating a height of the traffic light with reference to the vehicle from the image, and correcting the height of the traffic light calculated from the image based on information indicating a height difference between a road surface on which the vehicle is located and a road surface on which the traffic light is installed.

6. The driving assistance apparatus according to claim 1, wherein
the detection unit is configured to detect, from the image, a distance between the traffic light identified by the identification unit and a stop line provided in a traveling lane of the vehicle, and
the determination unit is configured to determine whether or not the traffic light identified by the identification unit is the target traffic light based further on the distance between the traffic light identified by the identification unit and the stop line.

7. The driving assistance apparatus according to claim 1, wherein
the detection unit is configured to detect, from the image, a lateral direction distance between the traffic light identified by the identification unit and the vehicle, and
the determination unit is configured to determine whether or not the traffic light identified by the identification unit is the target traffic light based further on the lateral direction distance detected by the detection unit.

8. The driving assistance apparatus according to claim 1, wherein
the detection unit is configured to detect, from the image, a traveling direction distance between the traffic light identified by the identification unit and the vehicle, and
the determination unit is configured to determine whether or not the traffic light identified by the identification unit is the target traffic light based further on the traveling direction distance detected by the detection unit.

9. The driving assistance apparatus according to claim 1, further comprising: an alarm control unit configured to output an alarm to a driver according to a lighting state of the target traffic light, in a case where the determination unit determines that the traffic light identified by the identification unit is the target traffic light.

10. The driving assistance apparatus according to claim 9, wherein the alarm control unit is configured to determine to output the alarm in a case where a lighting state of the target traffic light is red lighting or yellow lighting and a speed of the vehicle exceeds a threshold.

11. The driving assistance apparatus according to claim 9, wherein
in a case where a plurality of traffic lights are identified by the identification unit,
the detection unit is configured to detect, from the image, the installation height, a lateral direction distance from the vehicle, and a traveling direction distance from the vehicle for each of the plurality of traffic lights,
the determination unit is configured to
determine, as a first candidate for the target traffic light, a traffic light that has the installation height satisfying a predetermined condition and the shortest lateral direction distance among the plurality of traffic lights, based on a detection result by the detection unit, and
determine, as a second candidate for the target traffic light, a traffic light that has the installation height satisfying the predetermined condition and the shortest traveling direction distance among the plurality of traffic lights, based on a detection result by the detection unit, and
the alarm control unit is configured to determine whether or not to output the alarm according to a combination of a lighting state of the first candidate traffic light and a lighting state of the second candidate traffic light.

12. A vehicle comprising the driving assistance apparatus according to claim 1.

13. A driving assistance method for assisting driving of a vehicle, comprising:
capturing an image of the front of the vehicle;
identifying a traffic light in the captured image;
detecting, from the captured image, an installation height of the identified traffic light; and
determining whether or not the identified traffic light is a target traffic light indicating whether or not the vehicle travels, based on the detected installation height.

14. A non-transitory computer-readable storage medium storing a program for causing a computer to execute a driving support method according to claim 13.
